(19) United States
(12) Patent Application Publication
(10) Pub. No.: US 2022/0252059 A1
(43) Pub. Date: Aug. 11, 2022

(54) IMPROVED RUBBER SEALED PLUNGER ASSEMBLY

(71) Applicant: PADMINI VNA MECHATRONICS LTD., Gurgaon, Haryana (IN)

(72) Inventors: KABIR BHANDARI, NEW DELHI (IN); AMARDIP KUMAR, GURGAON (IN); KUMAR ABHISHEK, Gurgaon (IN); PARSURAM ROUT, Gurgaon (IN)

(21) Appl. No.: 17/626,832

(22) PCT Filed: Jul. 18, 2020
(86) PCT No.: PCT/IB2020/056780

§ 371 Date: Jan. 13, 2022

(30) Foreign Application Priority Data
Jul. 13, 2019 (IN) 201911028224

(51) Int. Cl. F04B 35/04; F04B 39/10

(52) U.S. Cl. CPC F04B 35/04; F04B 39/102; F04B 39/1013

(57) ABSTRACT

The present invention relates to an improved rubber sealed plunger assembly of electrical compressor by-pass valve. The present invention relates to an improved rubber sealed plunger assembly of electrical compressor by-pass valve with lip seal design to eliminate its over molding and improve performances like leakage and response time. The present invention provides an improved rubber sealed plunger assembly comprising of components including but not limited to a rubber disk cover, a rubber disk, a plunger body, a diaphragm and a diaphragm holder.

### FIELD OF THE INVENTION

The present invention relates to an improved rubber sealed plunger assembly of electrical compressor by-pass valve. More particularly, the present invention relates to an improved rubber sealed plunger assembly of electrical compressor by-pass valve with lip seal design to eliminate its over molding and improve performances like leakage and response time.

### BACKGROUND OF THE INVENTION

A compressor bypass valve is a mechanical device that makes use of vacuum action to release pressure from the intake system on various types of motors. Bypass valves are found in the engines of various types of planes and in some train engine designs as well. The compressor bypass valve helps to route the pressure generated within a turbo or supercharged engine back into the non-pressurized end of the intake system.

The main function of the compressor bypass valve is to allow the escape of pressure during the segment of operation when the throttle plate is closed. Without the presence of the valve to allow the pressure to be rerouted, the pressurized air would simply crash into the throttle plate thus building up the pressurized air and eventually be repelled back into the turbo. This strong wave of pressurized air would not only create additional wear on the turbo, but also slow down and possibly stop the action of the turbo altogether.

U.S. Pat. No. 5,253,713 discloses a system employing a plunger or “rabbit” device having a radially expansible portion and an electronic sequencer for controlling the overall gas and oil well system. An internal bypass valve permits the free flow of the particulates and liquids through an internal chamber of the tool during its return descent toward the producing formation. To efficiently utilize the pressure forces of gases trapped below the tool for lifting liquids to the surface when the bypass valve is closed, an elastomeric and expansible cylindrical sleeve is provided encircling a central region of the tool. Both the bypass valve and the elastomeric sleeve are operated by a slidable mechanical push rod received longitudinally within the tool body. The rod is actuated at extreme ends of the production pipe or conduit and detents provide for positive positioning of the rod during ascent and descent of the tool during well operation. A control system monitors conduit pressure and tool arrival to operate a sales valve and a tool release. The main drawback of the invention is that if the controller opens the well valve before the plunger reaches the bottom of the well and the plunger surfaces without liquid on top of the plunger, the plunger could be damaged, the lubricator could be damaged and the entire wellhead could be blown off.

U.S. Pat. No. 5,427,504 discloses a gas operated plunger for lifting well fluids from a subterranean reservoir to the surface through a well conduit comprising: a plunger body slidably mountable within the conduit having an upper portion, a lower portion and an intermediate cylindrical portion of reduced diameter; and a sealing assembly surrounding the intermediate cylindrical portion of the plunger body. The sealing assembly may include a plurality of longitudinally divided cylindrical segments of relatively smooth cylindrical surfaces for sliding and sealing contact with the well conduit walls to provide a seal which allows the plunger to gravitate through the well conduit to the reservoir and provides sufficient sealing upon an increase in gas pressure there below to elevate the plunger and well fluids there above to the surface.

Therefore, there is a need to develop a plunger assembly simple in design that reduces leakage and opening response time efficiently.

### OBJECT OF THE INVENTION

The main object of the present invention is to provide an improved rubber sealed plunger assembly to eliminate its over molding and improve performances like leakage and response time.

Another object of the present invention is to provide an improved and cost effective plunger assembly wherein diaphragm holder, rubber disk cover and plunger body are molded separately to provide a lip seal design and to reduce the overall cost of over molding.

Yet another object of the present invention is to improve the plunger assembly by assembling the molded parts not limited to diaphragm holder, rubber disk cover and plunger body manually and then welding them by laser welding.

Still another object of the present invention is to improve the plunger assembly by reducing the leakage efficiently from 70-72%.

### SUMMARY OF THE INVENTION

The present invention provides an improved rubber sealed plunger assembly of electrical compressor by-pass valve. More particularly, the present invention provides an improved rubber sealed plunger assembly of electrical compressor by-pass valve with lip seal design to eliminate its over molding and improve performances like leakage and response time.

In a main embodiment, the present invention provides an improved rubber sealed plunger assembly comprising of components including but not limited to a rubber disk cover, a rubber disk, a plunger body, a diaphragm and a diaphragm holder. The rubber disk cover is secured over the rubber disk and the rubber disk is fixed above the plunger body. The plunger body at base is surrounded by the diaphragm and is secured over the diaphragm holder forming the improved rubber sealed plunger assembly. The rubber disk is sandwiched between the rubber disk cover and the plunger body. The rubber disk has an outward extended lip seal such that the outer diameter of the rubber disk is greater than the outer diameter of the plunger body. The wall of the diaphragm holder and plunger body have a duct that helps in improving the response time. The components of the plunger assembly are molded separately. After molding, they are assembled manually and then welded with laser welding. The laser welding is done in the welding zones wherein one welding zone is between rubber disk cover and diaphragm holder and other welding zone is between the plunger body and diaphragm holder. The lip seal provided by the rubber disk is supported by the rubber disk cover which reduces the leakage from 70-72%, improves the actuating voltage and improves the opening response time.

In an alternative embodiment, the present invention provides an improved rubber sealed plunger assembly comprising of components including but not limited to a rubber disk cover, a rubber disk, a plunger body, a diaphragm and a diaphragm holder. The rubber disk is sandwiched between the rubber disk cover and the plunger body. The rubber disk has at least two concentric ribs on top and bottom side of the rubber disk for improved leakage and response time. The rubber disk has a lip seal in conformity with the gap between plunger body and rubber disk cover such that the outer diameter of the rubber disk is equal to the outer diameter of the plunger body. The lip seal provided by the rubber disk is supported by the rubber disk cover which reduces the leakage, improves the actuating voltage and improves the opening response time by reducing it by 30%.

### BRIEF DESCRIPTION OF THE DRAWING

A complete understanding of the device and method of the present invention may be obtained by reference to the following drawing:

FIG. 1(a) and FIG. 1(b) is an exploded view and perspective view of an improved rubber sealed plunger assembly in accordance to the present invention.

FIG. 2 shows the sectional view of an improved rubber sealed plunger assembly in accordance to an embodiment of the present invention.

FIG. 3(a) and FIG. 3(b) shows the comparison graph showing the leakage and response time respectively in improved rubber sealed plunger assembly in accordance to an embodiment of the present invention.

FIG. 4(a) shows the sectional view of an improved rubber sealed plunger assembly in accordance to an alternative embodiment of the present invention.

FIG. 4(b) shows the perspective view of the rubber disk with concentric ribs in accordance to an alternative embodiment of the present invention.

FIG. 5 shows the comparison graph showing the response time respectively in improved rubber sealed plunger assembly in accordance to an alternative embodiment of the present invention.

### DETAILED DESCRIPTION OF THE INVENTION

The present invention will now be described more fully hereinafter with reference to the accompanying drawings in which a preferred embodiment of the invention is shown. This invention may, however, be embodied in many different forms and should not be construed as being limited to the embodiment set forth herein. Rather, the embodiment is provided so that this disclosure will be thorough, and will fully convey the scope of the invention to those skilled in the art. Like numbers refer to like elements throughout.

The present invention provides an improved rubber sealed plunger assembly of electrical compressor by-pass valve. More particularly, the present invention provides the improved sealed rubber sealed plunger assembly of electrical compressor by-pass valve with lip seal design to eliminate its over molding and improve performances like leakage and response time.

In a main embodiment, the present invention provides an improved rubber sealed plunger assembly comprising of components including but not limited to rubber disk cover, rubber disk, plunger body, diaphragm and diaphragm holder. The rubber disk cover is secured in the rubber disk and rubber disk is fixed above the plunger body. The plunger body is surrounded by the diaphragm and is secured in diaphragm holder forming it a plunger assembly. The rubber disk is sandwiched between the rubber disk cover and the plunger body. The rubber disk has an outward extended lip seal such that the outer diameter of the rubber disk is greater than the outer diameter of the plunger body. The wall of the diaphragm holder and plunger body have a duct that helps in improving the response time. The components used are molded separately. After molding, they are assembled manually and then welded with laser welding. The laser welding is done on the welding zones wherein one welding zone is between rubber disk cover and diaphragm holder and other welding zone is between the plunger body and diaphragm holder. The lip seal design is provided by the rubber disk supported by rubber disk cover which reduces the leakage from 60-72%, improves the actuating voltage and improves the opening response time.

In an alternative embodiment, the present invention provides an improved rubber sealed plunger assembly comprising of components including but not limited to a rubber disk cover, a rubber disk, a plunger body, a diaphragm and a diaphragm holder. The rubber disk is sandwiched between the rubber disk cover and the plunger body. The rubber disk has at least two concentric ribs on top and bottom side of the rubber disk for improved leakage and response time. The rubber disk has a lip seal in conformity with the gap between plunger body and rubber disk cover such that the outer diameter of the rubber disk is equal to the outer diameter of the plunger body. The lip seal provided by the rubber disk is supported by the rubber disk cover which reduces the leakage, improves the actuating voltage and improves the opening response time by reducing it by 30%.

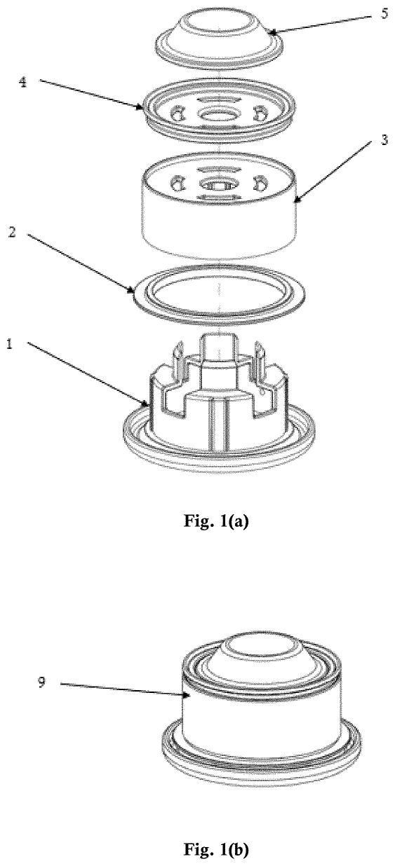

Now referring to FIG. 1(a) and FIG. 1(b), the present invention provides an exploded view and a perspective view of an improved sealed rubber plunger assembly 9 comprising of components including but not limited to a rubber disk cover 5, a rubber disk 4, a plunger body 3, a diaphragm 2 and a diaphragm holder 1. The rubber disk cover 5 is secured in the rubber disk 4 and the rubber disk 4 is sandwiched between the rubber disk cover 5 and the plunger body 3. The plunger body 3 at base is surrounded by the diaphragm 2 and is secured in diaphragm holder 1 forming a plunger assembly. The components are molded separately, assembled and welded with laser welding. The rubber disk cover 5 provides the support of rubber disk 4 and becomes the sealing surface that provides the lip seal design. The assembly reduces the leakage efficiently from 70-72%.

The diaphragm holder 1, plunger body 3 and rubber disk cover 5 is made of material not limited to polyphthalamide (PPA). The diaphragm 2 is made of material not limited to fluorocarbon (FKM) material. The rubber disk 4 is made of material including but not limited to fluorosilicone.

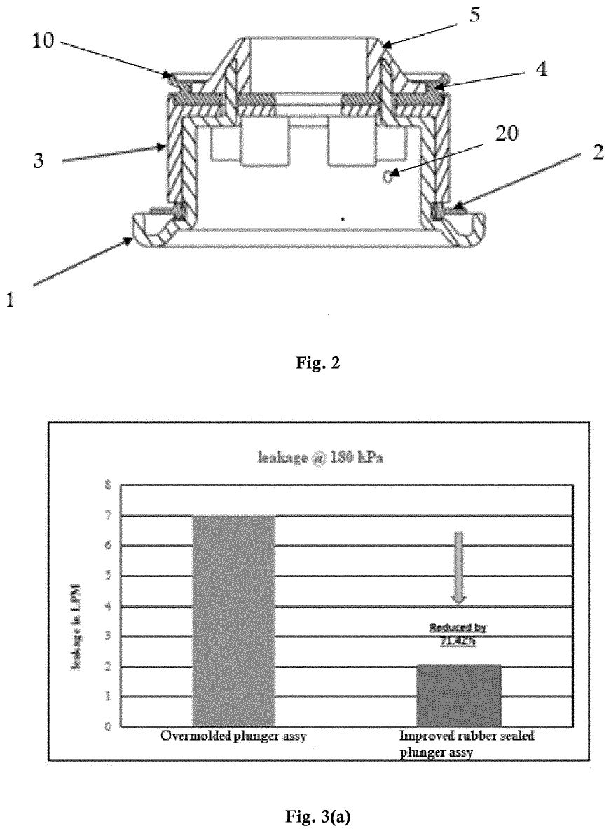

Now referring to FIG. 2, the present invention provides the sectional view of the improved rubber sealed plunger assembly 9. The sectional view shows components such as rubber disk cover 5, rubber disk 4, plunger body 3 and diaphragm 2 resting on diaphragm holder 1. The rubber disk 4 is sandwiched between rubber disk cover 5 and the plunger body 3. The plunger body 3 is set over and surrounded by the diaphragm 2. All the components rest on diaphragm holder 1 forming the plunger assembly. The side wall of the diaphragm holder 1 and plunger body 3 have a duct 20 which is optionally coinciding and helps in improving the response time. The rubber disk 4 has an outward protrusion i.e. lip seal 10 which is outwardly extended and with help of the rubber disk cover 5 the working performance parameters of plunger assembly is improved such as improvement of leakage efficiently, improvement in opening response time and actuating voltage. There are laser welding zones of an improved rubber sealed plunger assembly 9. The laser welding is done after assembling all the components manually. The laser welding is done on the laser welding zone and not on the rubber parts. The first laser welding zone is between the rubber disk cover 5 and diaphragm holder 1 and the second laser welding zone is between the plunger body 3 and diaphragm holder 1. The welding is only done on the plastic parts including diaphragm holder 1, plunger body 3 and rubber disk cover 5.

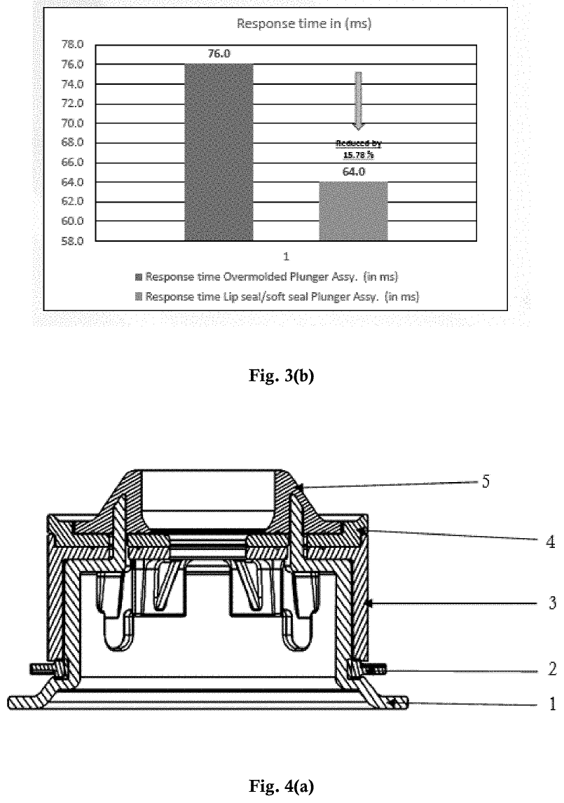

Now referring to FIG. 3(a), the comparison graph showing the leakage in improved rubber sealed plunger assembly. The improved rubber sealed plunger assembly in comparison to a conventional overmolded design of plunger assembly reduces the leakage in the range of 70-72% most preferably by 71.42% at the rate of 180 kPa. FIG. 3(b) shows comparison graph for response time of an improved rubber sealed plunger assembly. The response time in improved rubber sealed plunger assembly is reduced by 14-16% most preferably 15.78% as compared to overmolded plunger assembly. The response time comes out to be in range of 62-66 ms most preferably 64 ms.

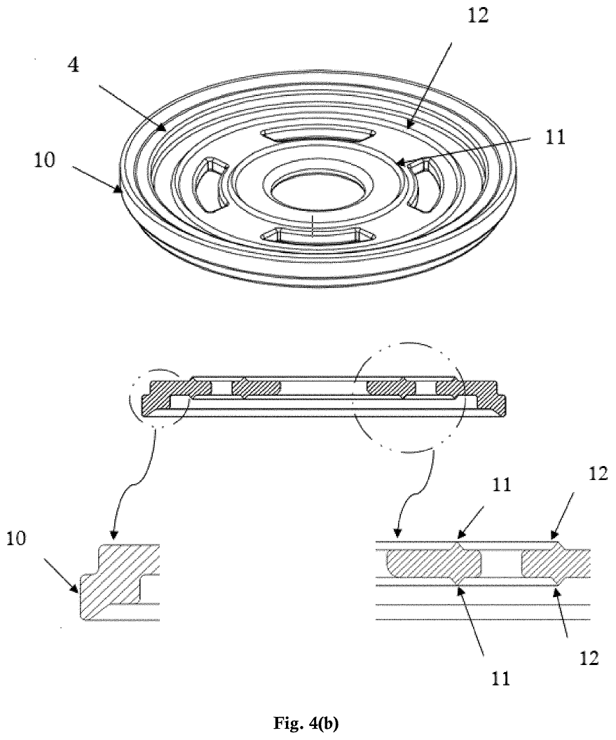

Referring to FIG. 4(a), a sectional view of an improved rubber sealed plunger assembly in accordance to an alternative embodiment of the present invention. The improved sealed rubber plunger assembly 9 comprising of components including but not limited to a rubber disk cover 5, a rubber disk 4, a plunger body 3, a diaphragm 2 and a diaphragm holder 1. The rubber disk cover 5 is secured in the rubber disk 4 and the rubber disk 4 is sandwiched between the rubber disk cover 5 and the plunger body 3. The plunger body 3 at base is surrounded by the diaphragm 2 and is secured in diaphragm holder 1 forming a plunger assembly. The components are molded separately, assembled and welded with laser welding. The rubber disk cover 5 provides the support of rubber disk 4 and becomes the sealing surface that provides the lip seal design. The rubber disk 4 has at least two concentric ribs 11, 12 on top and bottom side of the rubber disk 4 for improved leakage and response time. The rubber disk 4 has a lip seal 10 in conformity with the gap between plunger body 3 and rubber disk cover 5 such that the outer diameter of the rubber disk 4 is equal to the outer diameter of the plunger body 3. The lip seal 10 of the rubber disk 4 is supported by the rubber disk cover 5 which reduces the leakage, improves the actuating voltage and improves the opening response time by reducing it by 30%.

Referring to FIG. 4(b), the perspective view of the rubber disk 4 with concentric ribs 11, 12 in accordance to an alternative embodiment of the present invention. The concentric ribs 11, 12 on both the top and bottom side of the rubber disk 4 helps in improving the leakage and reduces the response time. The concentric rib(s) 11 on top and bottom side of the rubber disk 4 overlap each. Similarly, the concentric rib(s) 12 also overlap each other on both top and bottom side of the rubber disk 4.

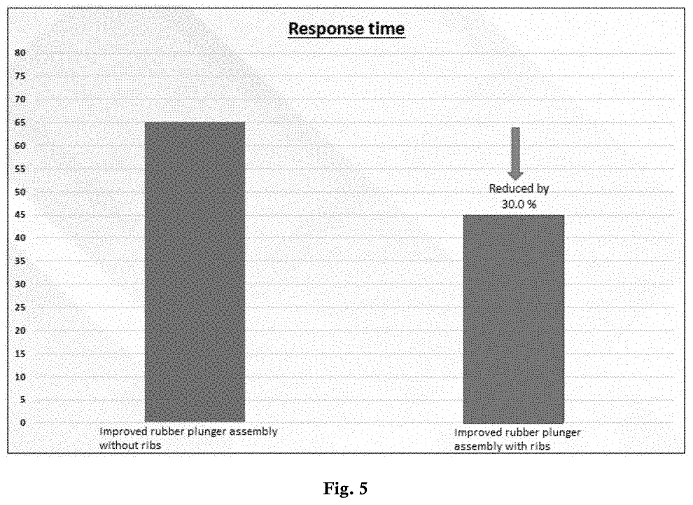

FIG. 5 shows the comparison graph showing the response time respectively in improved rubber sealed plunger assembly in accordance to an alternative embodiment of the present invention. The response time in improved rubber sealed plunger assembly with concentric ribs is reduced by 30% as compared to improved rubber plunger assembly without ribs. The response time comes out to be in range of 42-48 ms most preferably 45 ms.

Therefore, the improved rubber sealed plunger assembly in present invention is cost effective and helpful in providing the sealing with reduced leakage by 71.42% as well as improving response time by 30%.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

We claim:

1. An improved rubber sealed plunger assembly (9) of an electrical compressor by-pass valve comprising:
a diaphragm holder (1);
a diaphragm (2) fitted around the diaphragm holder (1);
a plunger body (3);
a rubber disk (4); and
a rubber disk cover (5);
wherein,
the plunger body (3) at base is surrounded by the diaphragm (2) and is secured in said diaphragm holder (1);
said diaphragm holder (1), diaphragm (2), plunger body (3), rubber disk (4) and the rubber disk cover (5) are molded separately, assembled together using a welding technique;
said disk (4) is sandwiched between the rubber disk cover (5) and plunger body (3) and has an outwardly extended lip seal (10);
said improved rubber plunger assembly (9) has a leakage efficiency reduced by 70-72% at rate of 180 kPa;
said diaphragm holder (1) and said plunger body (3) on side wall have a duct (20); and
said improved rubber plunger assembly (9) has a response time of 62-66 ms which is 14-16% less than response time of overmolded plunger assembly.

2. The assembly (9) as claimed in claim 1, wherein the welding technique is preferably laser welding.

3. The assembly (9) as claimed in claim 1, wherein the diaphragm holder (1), plunger body (3) and rubber disk cover (5) is made of material including but not limited to polyphthalamide (PPA).

4. The assembly (9) as claimed in claim 1, wherein the outwardly extended lip seal (10) of the rubber disk (4) has an outer diameter greater than outer diameter of the plunger body (3).

5. The assembly (9) as claimed in claim 1, wherein the diaphragm (2) is made of a material including but not limited to fluorocarbon (FKM) material and the rubber disk (4) is made of a material including but not limited to fluorosilicone.

6. An improved rubber sealed plunger assembly (9) of an electrical compressor by-pass valve comprising:
a diaphragm holder (1);
a diaphragm (2) fitted around the diaphragm holder (1);
a plunger body (3);
a rubber disk (4); and
a rubber disk cover (5);
wherein,
the plunger body (3) at base is surrounded by the diaphragm (2) and is secured in said diaphragm holder (1);
said diaphragm holder (1), diaphragm (2), plunger body (3), disk (4) and the disk cover (5) are molded separately, assembled together using a welding technique;
said rubber disk (4) is sandwiched between the disk cover (5) and plunger body (3) said rubber disk (4) has at least two concentric ribs (11, 12) on top and bottom side and a lip seal (10); and
said improved rubber plunger assembly (9) has a response time of 42-48 ms.

7. The assembly (9) as claimed in claim 6, wherein the welding technique is preferably laser welding.

8. The assembly (9) as claimed in claim 6, wherein the diaphragm holder (1), plunger body (3) and rubber disk cover (5) is made of material including but not limited to polyphthalamide (PPA).

9. The assembly (9) as claimed in claim 6, wherein the diaphragm (2) is made of a material including but not limited to fluorocarbon (FKM) material and the rubber disk (4) is made of a material including but not limited to fluorosilicone.

10. The assembly (9) as claimed in claim 6, wherein the response time of improved rubber plunger assembly (9) having rubber disk (4) with concentric ribs (11, 12) is 28-32% less than improved rubber plunger assembly (9) having rubber disk (4) without ribs.
